(19) United States
(12) Patent Application Publication
(10) Pub. No.: US 2011/0081585 A1
(43) Pub. Date: Apr. 7, 2011

(54) Process for Co-Production of Power and Carboxylic Acids

(75) Inventor: Donald Montgomery, Cheyenne, WY (US)

(73) Assignee: Nanomaterials Discovery Corporation

(21) Appl. No.: 12/897,727

(22) Filed: Oct. 4, 2010

Related U.S. Application Data
(60) Provisional application No. 61/248,470, filed on Oct. 4, 2009.

(51) Int. Cl. H01M 8/06; H01M 8/22

(52) U.S. Cl. 429/415; 429/416; 429/506

(57) ABSTRACT

There is disclosed a process for simultaneous co-production of electric power and a short chain carboxylic acid or salt thereof from a primary alcohol fuel. The primary alcohol can be obtained from coal, natural gas, wood waste or other biomass material. Moreover, there is disclosed a process that does not produce or release carbon dioxide and other greenhouse gasses. Specifically, there is disclosed a liquid fuel cell process technology provides electric power from coal, via a primary alcohol fuel, and allows a commercial scale electric power generating facility to capture at least 70% of the carbon contained in coal (or another carbon-based fuel source such as methane or biomass) for a beneficial and economically favorable use. The captured carbon is converted by the disclosed fuel cell process technology into industrial commodity chemicals such as formic and acetic acids.

### CROSS REFERENCE TO RELATED APPLICATION

This disclosure claims priority to U.S. Provisional Patent Application 61/248,470 filed 4 Oct. 2009.

### TECHNICAL FIELD

The present disclosure provides a process for simultaneous co-production of electric power and a short chain carboxylic acid or salt thereof from a primary alcohol fuel. The primary alcohol can be obtained from coal, natural gas, wood waste or other biomass material. Moreover, the disclosed process does not produce or release carbon dioxide and other greenhouse gasses. Specifically, the present disclosure provides a liquid fuel cell process technology provides electric power from coal, via a primary alcohol fuel, and allows a commercial scale electric power generating facility to capture at least 70% of the carbon contained in coal (or another carbon-based fuel source such as methane or biomass) for a beneficial and economically favorable use. The captured carbon is converted by the disclosed fuel cell process technology into industrial commodity chemicals such as formic and acetic acids.

### BACKGROUND

Coal is a fossil fuel formed in ecosystems where plant remains were preserved by water and mud from oxidization and biodegradation, thus sequestering atmospheric carbon. Coal is a readily combustible black or brownish-black rock. It is a sedimentary rock, but the harder forms, such as anthracite coal, can be regarded as metamorphic rock because of later exposure to elevated temperature and pressure. It is composed primarily of carbon and hydrogen along with small quantities of other elements, notably sulfur. Coal is extracted from the ground by coal mining.

Coal is the largest source of fuel for electric power generation worldwide, as well as the largest worldwide source of carbon dioxide emissions. Carbon dioxide is a greenhouse gas and these emissions are likely contributing to an increase in global average temperature and related climate changes. Gross carbon dioxide emissions from coal usage are slightly more than that from petroleum and about double the amount from natural gas. Therefore, there is a significant need in the art to be able to utilize coal as an abundant energy source without generating significant amounts of carbon dioxide.

Coal is primarily used as a solid fuel to produce electricity and heat through combustion. World coal consumption is about 6.2 billion tons annually. China produced 2.38 billion tons in 2006 and India produced about 447.3 million tons in 2006. 68.7% of China's electricity comes from coal. The U.S. consumes about 1.053 billion tons of coal each year, using 90% of it for generation of electric power. The world in total produced 6.19 billion tons of coal in 2006.

Carbon dioxide and carbon monoxide are generated by full oxidation and partial oxidation of coal and wood-based fuels, natural gas, and biomass, that is, other plant based materials. Hydrocarbons from a solid feedstock, such as coal or solid carbon-containing plant materials of various types can be produced by using synthesis gas (syngas), which is a mixture of carbon monoxide and hydrogen. Pyrolysis of the solid material produces syngas, which can be used to produce hydrocarbon products, for example, by being taken through Fischer-Tropsch transformations. Natural gas can also be used to produce syngas.

Fischer-Tropsch transformations of syngas can form primary alcohols (mostly methanol or ethanol, but also longer chain alcohols) and various ether-containing organic molecules.

Due to the high cost of crude petroleum, refined petroleum products and natural gas, as well as the unreliability of the sources and limited reserves of these fuels, it has become necessary that different energy sources be explored and new techniques for the effective utilization of all sources of energy be developed. Moreover, due to global climate change concerns, there is a need to be able to generate electric power without releasing CO₂ somewhere in the cycle or process.

The gasification process produces a synthesis gas having, typically, a 0.7/1 to 1.2/1 ratio of H₂ to CO together with lesser amounts of CO₂, H₂S, methane and other chemical products. Attempts have been made to improve the conversion of syngas by recycling streams enriched in H₂ or CO as exemplified by U.S. Pat. Nos. 4,946,477, 5,284,878 and 5,392,594, but the maximum syngas conversions disclosed are less than 75%. The equilibrium limit for DME formation is greater than for methanol, so conversions up to about 77% are achievable as disclosed, for example, in U.S. Pat. No. 4,341,069. DME, however, is normally a gaseous component and must be chilled and compressed for storage, with the concomitant higher capital cost.

Electric power is generated in a gasification combined cycle (GCC) systems in which coal or other carbonaceous material is gasified using oxygen to provide synthesis gas (“syngas”) containing the combustible components hydrogen and carbon monoxide. The synthesis gas, which also contains carbon dioxide and in some cases methane, is fired as fuel to a gas turbine system which drives a generator to produce electric power. Hot turbine exhaust is passed to a heat recovery system to produce high pressure steam which is expanded through a steam turbine to drive another electric generator to produce additional power. Such gasification combined cycle systems generate electricity in an efficient manner, but still generate copious quantities of CO₂.

The production of chemicals or liquid fuels from a portion of the synthesis gas in a gasification combined cycle system is known and has the advantages of common operating facilities and economy of scale in the coproduction of electric power and chemicals. Several references describe existing technology for combined chemical plant/GCC power plant operations. For example, U.S. Pat. No. 5,179,129 (the disclosure of which is incorporated by reference herein) describes the integration of a multi-stage liquid phase methanol plant with a standard GCC system. Excess heat of reaction from the methanol reactor is used to heat compressed synthesis gas reactor feed and boiler feed water, or to generate steam for the generation of additional electric power. U.S. Pat. No. 4,946,477 (the disclosure of which is incorporated by reference herein) describes a liquid phase methanol/GCC system without specific heat integration between the methanol and GCC plants.

U.S. Pat. No. 4,676,063 (the disclosure of which is incorporated by reference herein) describes a methanol synthesis/GCC system with multiple parallel modules for operating flexibility. Heat from the acid gas removal system of the GCC plant is sent to the methanol plant to saturate the syngas feed stream with water before employing a water-gas shift to increase hydrogen in the feed stream to the methanol reactor. No heat from the methanol plant is used in the GCC system. U.S. Pat. Nos. 4,663,931 and 4,665,688 (the disclosures of which are incorporated by reference herein) describe essentially the same system in which a portion of the methanol product provides feed for the production of acetic acid or vinyl acetate respectively. In both cases heat of reaction from the methanol plant is used to generate steam.

U.S. Pat. No. 4,277,416 (the disclosure of which is incorporated by reference herein) describes a basic methanol plant with syngas feed from a coal gasifier or steam methane reformer with no specific heat integration. This patent also describes an operation in which some of the syngas is combined with effluent nitrogen from an air separation plant to provide feed to a urea plant.

Heat from the reaction section of a combined GCC/chemical production system is utilized in the GCC system to generate steam for use in the steam turbine. GCC systems have environmental advantages over traditional power plants which utilize liquid or solid carbonaceous fuels, and oxygen-derived synthesis gas is an attractive feedstock for the coproduction of chemical or liquid fuel products and electric power.

A variety of catalysts can be used for the Fischer-Tropsch process, but the most common are the transition metals cobalt, iron, and ruthenium. Nickel can also be used, but tends to favor methane formation. Cobalt seems to be the most active catalyst, although iron also performs well and can be more suitable for low-hydrogen-content synthesis gases such as those derived from coal due to its promotion of the water-gas-shift reaction. In addition to the active metal the catalysts typically contain a number of promoters, including potassium and copper, as well as high-surface-area binders/supports such as silica, alumina, or zeolites. Unlike the other metals used for this process (Co, Ni, Ru) which remain in the metallic state during synthesis, iron catalysts tend to form a number of chemical phases, including various iron oxides and iron carbides during the reaction. Control of these phase transformations can be important in maintaining catalytic activity and preventing breakdown of the catalyst particles.

Cobalt catalysts are preferred for Fischer-Tropsch synthesis when the feedstock is natural gas due to the higher activity of the cobalt catalyst. Natural gas has a high hydrogen to carbon ratio, so the water-gas-shift is not needed for cobalt catalysts. Iron catalysts are preferred for lower quality feedstocks such as coal or biomass. While iron catalysts are also susceptible to sulfur poisoning from coal with high sulfur content, the lower cost of iron makes sacrificial catalyst at the front of a reactor bed economical. Also, iron can catalyze the water-gas-shift to increase the hydrogen to carbon ratio to make the reaction more favorably selective.

### Carbon Sequestration and Cap and Trade System

In a cap and trade system as it is currently contemplated, a cap limit will be set on all U.S. carbon dioxide and other carbon emissions. Within that limit, individual company caps will be set. If a company goes under the cap, the company can sell its unused carbon credits to someone who is over the limit and needs credits. There would even be a carbon trading exchange for trading these credits.

The government would set limits on carbon dioxide emissions by power plants, factories and other installations, but allow those who emit more to buy or trade permits with companies and facilities that emitted less than the prescribed limit. The idea is that raising the cost of pumping more carbon dioxide into the atmosphere would encourage companies and other emitters to cut back, thus reducing a principal cause of global warming. Therefore, there is a need in the art to be able to take advantage of a cap and trade system (at the time of writing this disclosure, a cap and trade system has not been implemented within the United States) by generating power from natural gas, coal, wood products, or other biomass carbon-based fuels without generating greenhouse gasses (carbon dioxide or carbon monoxide or methane) to further improve the economics of the disclosed system by generating cap and trade carbon emissions credits while continuing to generate power.

### SUMMARY

Surprisingly, the cost of electricity (COE) obtained by the disclosed process is a result of both the improved efficiency for electric power generation attained by using the disclosed fuel cell process technology, and from the commercial sale of industrial commodity chemicals. It is of interest that the commercial value of these industrial commodity chemicals is substantially in excess of the commercial value of the electric power. In general, electric power generation from carbon-based fuels such as coal or wood waste involve direct combustion and always produces carbon dioxide (CO₂) and , often, carbon monoxide, both greenhouse gasses. Carbon-based products derived from coal, wood waste or other biomass materials (such as coke, syngas and methanol/ethanol), when combusted, also produce CO₂. The present disclosure utilizes carbon-based products derived from coal, natural gas, wood waste, or other biomass materials (e.g., coke, syngas and methanol/ethanol) to produce electric power, and carboxylic acids, and most importantly, much less CO₂. Therefore, once a cap-and-trade system is implemented in the U.S., the disclosed process will be eligible to receive carbon credits for generating electric power from carbon-based fuels such as coal, natural gas, wood waste or other biomass materials without generating nearly as much CO₂ or other greenhouse gasses as combustion processes, because the carbon is captured as a valuable carboxylic acid product, such as acetic acid or formic acid.

The present disclosure provides a process for obtaining economic value from carbon-based fuels. More particularly, the present disclosure provides a process comprising:

(a) forming syngas;

(b) forming a primary alcohol or polyol from the syngas, wherein the primary alcohol or polyol comprises one or a plurality of hydroxyl moieties; and

(c) providing the primary alcohol or polyol to a fuel cell; and

(d) producing power from the fuel cell while converting each hydroxyl moiety to a carboxylic acid moiety or salt thereof.

Preferably, the primary alcohol or polyol is selected from the group consisting of methanol, ethanol, propanol, isopropanol, ethylene glycol, glycerol, hexane-1,6-diol and combinations or mixtures thereof. Most preferably, the primary alcohol is selected from the group consisting of methanol, ethanol, ethylene glycol and combinations thereof. Preferably, the primary alcohol or polyol is mixed with base to form a fuel in electrolyte for the fuel cell. Preferably, the fuel cell has a cathode having a hydrophobic surface to prevent cathode flooding. Preferably, the fuel cell comprises:

(a) an enclosed fuel cell having an anode chamber and a cathode chamber, wherein the anode chamber is separated from the cathode chamber by a porous separator or just a spacer that allows the free transfer of liquids and ions between the chambers and has an average pore diameter of from about 10 nm to about 1000 nm;

(b) the anode chamber comprises an anode electrode having a catalyst thereon, and a mixture of fuel and an electrolyte; and

(c) the cathode chamber comprises a hydrophobic coated cathode electrode having a catalyst thereon and oxygen gas; and wherein the anode electrode and the cathode electrode are electrically connected to leads for current flow, and wherein the enclosed fuel cell is capable of producing at least 10 mA/cm² of electrode area. Preferably, the fuel comprises a primary alcohol or polyol at a concentration of from about 5% (by volume) to about 100% (by volume). More preferably, the concentration of alcohol or polyol is from about 10% to about 50% by volume. Preferably, the fuel further comprises an electrolyte wherein the electrolyte is selected from the group consisting of a base, an acid, a non-aqueous base, a non-aqueous acid. More preferably, the electrolyte is an aqueous base, wherein the pH is sufficient to completely ionize the alcohol. Most preferably the fuel is ethanol or methanol. Preferably, the coated electrode cathode is coated by a hydrophobic polymer selected from the group consisting of polyamides, polyimides, fluoropolymers, organosubstituted silica, organo-substituted titania, and combinations thereof.

The present disclosure further provides a process for generating power in a fuel cell and for forming acetate or formate or oxalate through an incomplete oxidation of ethanol or methanol or ethylene glycol, comprising:

(a) providing a fuel cell comprising:
(i) an enclosed fuel cell having an anode chamber and a cathode chamber, wherein the anode chamber is separated from the cathode chamber by a porous separator that allows the free transfer of liquids and ions between the chambers;
(ii) the anode chamber comprises an anode electrode having a catalyst thereon, and a mixture of fuel and an electrolyte; and
(iii) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm²; and

(b) mixing the ethanol or methanol or both with base to form the fuel for the fuel cell.

Preferably, the fuel cell has a cathode having a hydrophobic surface to prevent cathode flooding. Preferably, the fuel comprises an alcohol or polyol at a concentration of from about 5% (by volume) to about 100% (by volume). More preferably, the concentration of alcohol or polyol is from about 10% to about 50% by volume. Preferably, the fuel mixture further comprises an electrolyte wherein the electrolyte is selected from the group consisting of a base, an acid, a non-aqueous base, and a non-aqueous acid. More preferably, the electrolyte is an aqueous base, wherein the pH is sufficient to completely ionize the alcohol. Most preferably the fuel is ethanol or methanol or ethylene glycol or glycerol or mixtures thereof. Preferably, the coated electrode cathode is coated by a hydrophobic polymer selected from the group consisting of polyamides, polyimides, fluoropolymers, organo-substituted silica, organo-substituted titania, and combinations thereof.

The present disclosure further provides a process for generating power in a fuel cell with a carbon-based fuel and preventing carbon dioxide release, comprising:

(a) providing one or a plurality of fuel cells, wherein each fuel cell comprises:
(i) an enclosed fuel cell having an anode chamber and a cathode chamber, wherein the anode chamber is separated from the cathode chamber by a porous separator that allows the free transfer of liquids and ions between the chambers;
(ii) the anode chamber comprises an anode electrode having a catalyst thereon, a mixture of fuel and an electrolyte, a fuel inlet and a spent fuel outlet; and
(iii) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm²;

(b) providing a mixed primary alcohol fuel mixture added to the inlet of the anode chamber and a spent fuel obtained through the outlet of the anode chamber, wherein the spent fuel is substantially a carboxylic moiety of the original primary alcohol;

(c) obtaining corresponding carboxylic acids from the spent fuel outlet of the anode chamber;

(d) feeding the carboxylic acids from the spent fuel outlet of the anode chamber to a gasifier that functions as an anaerobic combustion chamber to provide waste hydroxide salts and syngas; and

(e) forming mixed alcohols from the syngas.

Preferably, the gasifier device has inputs for a carbon source, for carboxylic acids and for oxygen or air and outputs for coke (when coal is the carbon source) and ash. Preferably, the spent fuel is recirculated back to the inlet of the anode chamber in case additional primary alcohol was not completely converted to its corresponding carboxylic acid. Preferably, the fuel cell has a cathode having a hydrophobic surface to prevent cathode flooding. Preferably, the fuel comprises an alcohol or polyol at a concentration of from about 5% (by volume) to about 100% (by volume). More preferably, the concentration of alcohol or polyol is from about 10% to about 50% by volume. Preferably, the fuel mixture further comprises an electrolyte wherein the electrolyte is selected from the group consisting of a base, an acid, a non-aqueous base, a non-aqueous acid. More preferably, the electrolyte is an aqueous base, wherein the pH is sufficient to completely ionize the alcohol. Most preferably the fuel is ethanol or methanol or ethylene glycol or glycerol or mixtures thereof. Preferably, the coated electrode cathode is coated by a hydrophobic polymer selected from the group consisting of polyamides, polyimides, fluoropolymers, organo-substituted silica, organo-substituted titania, and combinations thereof.

The present disclosure further provides a closed loop system for converting a carbon source to power while avoiding atmospheric release of carbon containing greenhouses gases, comprising:

(a) one or a plurality of fuel cells, wherein each fuel cell comprises:
(i) an enclosed fuel cell having an anode chamber and a cathode chamber, wherein the anode chamber is separated from the cathode chamber by a porous separator that allows the free transfer of liquids and ions between the chambers;
(ii) the anode chamber comprises an anode electrode having a catalyst thereon, a mixture of fuel and an electrolyte, a fuel inlet and a spent fuel outlet; and
(iii) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm²;

(b) a mixed primary alcohol fuel mixture added to the inlet of the anode chamber and a spent fuel consisting essentially of a carboxylic acid moiety where the original primary hydroxyl moiety was, obtained through the outlet of the anode chamber, wherein the spent fuel is substantially a carboxylic moiety of the original primary alcohol; and

(c) a gasifier capable of functioning as an anaerobic combustion chamber and having one or a plurality of input ports for the carbon source, carboxylic acids and air and an output port. for solid products and alcohols.

Preferably, the carbon source is selected from the group consisting of solid hydrocarbons, coal, coal dust, liquid hydrocarbons, alkane gases, and combinations thereof. Preferably, the fuel cells are connected in a parallel configuration or a combination parallel and serial configuration. Preferably, the output of each fuel cell is tied together to a single input in a gasifier. More preferably, the fuel cell outputs are scrubbed to remove any SOx, NOx or heavy metals contained in the carboxylic acid stream produced. More preferably, the fuel cells are capable of being turned off and on in response to local or grid power demands. Preferably, the one or plurality of inputs for the gasifier provide an inlet for carbon source, carboxylic acids and optionally air, wherein the air input is shut when anaerobic combustion is required and the air input is open for aerobic combustion to produce heat and make electric power from heat. Preferably, the solids output of the gasifier comprises ash and hydroxide salts. More preferably, the solids output of the gasifer further comprises coke when coal is used as the carbon source. Preferably, the fuel cell has a cathode having a hydrophobic surface to prevent cathode flooding. Preferably, the fuel comprises an alcohol or polyol at a concentration of from about 5% (by volume) to about 100% (by volume). More preferably, the concentration of alcohol or polyol is from about 10% to about 50% by volume. Preferably, the fuel mixture further comprises an electrolyte wherein the electrolyte is selected from the group consisting of a base, an acid, a non-aqueous base, a non-aqueous acid. More preferably, the electrolyte is an aqueous base, wherein the pH is sufficient to completely ionize the alcohol. Most preferably the fuel is ethanol or methanol or ethylene glycol or glycerol or mixtures thereof. Preferably, the coated electrode cathode is coated by a hydrophobic polymer selected from the group consisting of polyamides, polyimides, fluoropolymers, organo-substituted silica, organo-substituted titania, and combinations thereof.

### DETAILED DESCRIPTION

The present disclosure provides a process to economically utilize carbon-based fuels such as coal to produce power, coke and a lower alkyl carboxylic acid (all items that can be sold). But most importantly, the disclosed process will generate much less CO₂ than coal that is combusted (generally around three tons of CO₂ per ton of coal) so as to be able to provide a carbon credit (tradeable) under a proposed cap-and-trade system. For example, when using the disclosed process with 475 tons per day of bituminous coal about 1,560 MWh per day of electric power is produced from the fuel cells and steam generators that capture excess heat. This corresponds to a net electric power production of about 3.3 MWh per ton of coal, which is an increase of over 50% from conventional combustion based means of making electric power. Additionally, 455 tpd of formic acid and 212 tpd of acetic acid will be produced for sale as industrial commodity chemicals. CO₂ production from this process is one third of the amount produced per ton of coal by conventional combustion based means of producing electric power. Greenhouse gasses are reduced by two thirds without requiring additional infrastructure for capture or sequestration.

| Commodity | Output per ton of coal |
|---|---|
| Electric power | 3.28 MWh |
| Formic acid | 0/96 ton |
| Acetic acid | 0.45 ton |
| Carbon dioxide emitted | 1.08 ton |
| Carbon dioxide captured | 2.59 ton |

The disclosed process forms first syngas and coke through a known process steps and then forms alcohols, primarily ethanol and methanol, again through a known process step using Fischer Tropsch catalysts. The syngas formed can be used to make diesel, gasoline or alcohols (such as ethanol or methanol) through known Fischer-Tropsch processes. The syngas can also be used to make ammonia. However, the products formed from syngas by these processes are generally used for combustion reactions. Such combustion reactions form copious quantities of CO₂. The disclosed process, by contrast, utilizes the a primary alcohol, such as ethanol (or a lower alkyl primary alcohol or polyalcohol such as 1,6 dihydroxy hexane) formed and then only partially oxidizes into its corresponding carboxylic acid, such as acetic acid from ethanol, and no CO₂, wherein the acetic acid has a much higher value as a product than will the CO₂ otherwise generated through combustion. Therefore, the present disclosure provides a process that is both novel in its compilation of steps, and provides significant economic and environmental advantages. Such economic advantages are augmented by possible or even likely future implementation of a cap and trade system for carbon credits.

If coal is used as the carbon source and using the disclosed process, over 60% of the CO₂ that would otherwise be produced by the direct combustion of coal goes instead to a carboxylic acid product. Yet the efficient fuel cell production makes about 82% more electric power per unit mass of coal. This allows for production of electric power at competitive rates. In addition to the carbon capture (in a carboxylic acid) advantages of a mixed primary alcohol feedstock, there is also available a $3000 per kW tax credit available for installed systems.

Initial simulations of plant operations have assumed 80% carbon and 4% hydrogen in the bituminous coal source. The overall plant is modeled as five interconnected process modules.

The fuel cell process module produces carboxylic acid products that are removed from the process stream by, for example, an ion-exchange process. These carboxylic acid products can then be separated to produce the corresponding commercial commodities. Because the conversion yields are quantitative, very little, if any, purification of the carboxylic acids is required to produce a commercial grade product. Alternatively, all or a portion of the carboxylic acid products can be returned to the gasifier module to be reused. Alternatively, all or a portion of the carboxylic acid products can be combusted to produce additional heat while utilizing such heat produced for cogeneration purposes or for further electric power production.

The economic proposition provided by the co-production of electric power and valuable commodity chemicals is very compelling. It is estimated that the cost of a 70 MW output demonstration facility will be approximately $200 million. When operating at full capacity the facility will generate revenues of about $750,000 per day. The COE (cost of electricity) depends on the value of revenues accrued from the commercial sale of carboxylic acid products. The COE crosses zero when revenues from carboxylic acids exceed $250 per ton.

### Syngas to Ethanol (or Methanol or Both)

One process can selectively produce mixed alcohols from syngas comprising contacting a mixture of hydrogen and carbon monoxide with a catalytic amount of a catalyst wherein the catalyst is composed of components of:

(1) a catalytically active metal of molybdenum, tungsten or rhenium, in free or combined form;

(2) a co-catalytic metal of cobalt, nickel or iron, in 45 free or combined form;

(3) a Fischer-Tropsch promoter; and

(4) an optional support.

The components are combined by dry mixing, mixing as a wet paste, wet impregnation or if the first component is rhenium co-precipitation, and then sulfided, under conditions sufficient to form said product in at least 20 percent CO₂ free carbon selectivity. High yields and selectivity are obtained without the use of rhodium, copper, ruthenium or zinc, but with cobalt, iron or nickel added to the catalyst the ratio of 1 to 2.5 alcohols may be considerably lower than for the same catalyst without the iron, nickel or cobalt, while still retaining the high catalyst activity and low sulfur level mixed alcohol fraction. The process is heterogeneously catalyzed. The process itself is efficient in conversion of synthesis gas into mixed alcohols.

The molar ratio of hydrogen to carbon monoxide in the feed gas which contacts the catalyst is such that the mixed alcohols are produced. Preferably, lower limits of the ratio are about 0.25, more preferably about 0.5 and most preferably about 0.7. Preferably, equivalent upper limits are about 100, more preferably about 5 and most preferably about 3. A most preferred range of from about 0.7 to about 1.2 holds for unsupported Fischer-Tropsch promoted sulfided Co/Mo catalysts. Generally, selectivity to alcohols is dependent on the pressure. Pressures are such that the mixed alcohols are produced. In the normal operating ranges, the higher the pressure at a given temperature, the more selective the process will be to alcohols. The minimum preferred pressure is about 500 psig (3.55 MPa). The more preferred minimum is about 750 psig (5.27 MPa) with about 1,000 psig (7.00 MPa) being a most preferred minimum. While about 1,500 psig (10.45 MPa) to about 4,000 psig (27.7 MPa) is the most desirable range, higher pressures may be used and are limited primarily by cost of the high pressure vessels, compressors and energy costs needed to carry out the higher pressure reactions. About 10,000 psig (69.1 MPa) is a typical preferred maximum with about 5,000 psig (34.6 MPa) a more preferred maximum. About 3,000 psig (20.8 MPa) is a most preferred pressure for the catalyst.

Selectivity to alcohols is also a function of temperature and is interrelated with the pressure function. Temperatures are such that the mixed alcohols are produced. However, the minimum temperature used is governed by productivity considerations and the fact that at temperatures below about 200° C., volatile catalytic metal carbonyls may form. Accordingly, the preferred minimum temperature is generally about 200° C. A preferred maximum temperature is about 400° C. A more preferred maximum is about 350° C. The most preferred range of operation is from about 240° C. to about 325° C.

The Ha/CO gas hourly space velocity (GHSV) is a measure of the volume of hydrogen plus carbon monoxide gas at standard temperature and pressure passing a given volume of catalyst in an hour's time. GHSV is such that the mixed alcohols are produced. Preferably, lower limits of GHSV are about 100/hour and more preferably about 2,000/hour. Preferably, equivalent upper limits are about 20,000/hour and more preferably about 5,000/hour. Selectivity to the alcohols usually increases as the space velocity decreases. Conversion of carbon monoxide decreases as space velocity increases.

In addition, the synthesis should be carried out at as little feed conversion per pass as is compatible with economic constraints related to the separation of the alcohol product from unreacted feed and hydrocarbon gases. Accordingly, one would increase the space velocity and recycle ratios to preferably obtain about 15-25 percent conversion per pass. The metal in the catalytically active metal may be of molybdenum (i.e., Mo), tungsten (i.e., W) and/or rhenium (i.e., Re). Mo and W are a more preferred group. Molybdenum is most preferred. In the finished catalyst, the Mo, W or Re may be present in free of combined form. In free or combined form means the metal component at hand may be present as a metal, alloy or compound of the metal component. In the case of Mo, W and Re, the sulfides, carbonyls, carbides and oxides are preferred in the finished catalyst. The sulfides are most preferred.

Typically, the catalytically active metal is generally present in the finished catalyst as the sulfide. It is not necessary that any particular stoichiometric metal sulfide be present, only that the metal sulfide is catalytically active itself for mixed alcohols production from synthesis gas before mixing with the co-catalytic metal and is generally present in combination with sulfur. Some of the catalytically active metal sulfide may be present in combination with other elements such as oxygen or as oxysulfides. The atomic ratio of sulfur to the metal in the catalytically active metal separately from the co-catalytic metal preferably has a lower limit of about 0.1 and more preferably a lower limit of about 1.8. Preferably, equivalent upper limits are about 3, more preferably about 2.3. Most preferably, the catalytically active metal comprises a catalytically active metal disulfide.

The catalytically active metal may be prepared by any known method. For example, agglomerated molybdenum sulfide catalysts may be made by thermal decomposition of ammonium tetrathiomolybdate or other thiomolybdates, as disclosed in U.S. Pat. Nos. 4,243,553 and 4,243,554 (both incorporated by reference herein), from purchased active molybdenum sulfides, or by calcining MoSs. A preferred method of preparing catalytically active molybdenum sulfide is by decomposing ammonium tetrathiomolybdate that is formed by reacting a solution of ammonium heptamolybdate with ammonium sulfide followed by spray drying and calcining to form the molybdenum sulfide. Tungsten preparations are often similar. The addition of precipitating liquids, evaporation and cooling may be employed and may be advantageous with all catalyst metal components.

Representative molybdenum-, tungsten- or rhenium- containing compounds which may be used in preparing the catalyst include the sulfides, carbides, oxides, halides, nitrides, borides, salicylides, oxyhalides, carboxylates such as acetates, acetyl acetonates, oxalates, carbonyls, and the like. Representative compounds also include the elements in anionic form such as molybdates, phosphor-molybdates, tungstates, phosphor-tung-states, perrhenates and the like, and especially include the alkali, alkaline earth, rare earth and actinide series compounds of these anions.

### Primary Alcohol or Polyol-Based, Membrane-Less Fuel Cell

The fuel cell is an alkaline fuel cells that utilize primary alcohols as anode fuels. The fuel cell has been evaluated using a wide range of primary alcohols, including diols such as ethylene glycol, and found to produce electric power by oxidizing the primary alcohol moieties to their corresponding carboxylic acids.

This chemical conversion is quantitative. Intermediate oxidation products, such as aldehydes, were not produced in measurable quantities. Further, the oxidation stopped at the carboxylic acid stage and showed no evidence of cleaving carbon-carbon bonds. Therefore, the fuel cell will not produce CO₂ directly from a primary alcohol fuel.

Alkaline direct alcohol fuel cells (DAFC) have utilized a permselective electrolyte membrane to separate the anode and the cathode. Permselective anion exchange membranes for DAFC applications are expensive and of highly variable quality. The permselective membrane is the primary failure mode and performance limiting feature of conventional DAFCs. Atmospheric CO₂, which accompanies air at the cathode, will quickly cause a build up of insoluble carbonates within the permselective membrane resulting in an irreversible and systematic increase in the IR drop across the membrane. Rapid degradation of the performance of the DAFC ensues as the membrane deteriorates. However, the present disclosure has resolved the root cause of DAFC performance problems associated with the permselective membrane in DAFCs by simply eliminating it. The result is a robust alkaline fuel cell that does not suffer performance damage due to insoluble carbonate accumulation. The disclosed DAFCs show substantial lifetime improvements over conventional DAFCs. Eliminating the permselective membrane also has the added benefit of removing one of the most expensive DAFC components from the bill of materials. Performance testing of the disclosed fuel cells has demonstrated lifetimes in excess of 4,000 hours without catalyst regeneration.

Producing robust and cost effective DAFCs also enhances the economic prospects for fuel cell power plants because the use of liquid fuel feedstock at the anode simplifies the physical plant required to operate fuel cell stacks. Complex ancillary equipment in the physical plant such as the mass flow controllers, compressors, humidifiers, and complex control loops are eliminated along with the associated parasitic losses. In a preferred embodiment of DAFCs, air can be provided to the cathode by axial fans and the anode fuel doubles as a cooling system.

While alkaline fuel cells offer superior cost effectiveness, the trade off usually is the power density attainable from the fuel cell. This is a major drawback for transportation applications where the mass and volume of the electric power source are primary issues. Power density is a secondary consideration for stationary applications where capital and operating costs are the primary drivers.

A key component of the disclosed alkaline fuel cells is the coated conductive electrode cathode, preferably having a hydrophobic microporous layer (MPL) adjacent to the porous separator. The MPL layer of the cathode can be made, for example, by immersing carbon paper in a fluoropolymer mixture, such as a Teflon (PTFE) emulsion. Once immersed, the polymer is sintered or heated to its glass transition temperature (347° F.) to make the conductive carbon paper hydrophobic. The cathode catalyst can be applied by, for example, a spray on process using an air brush.

The disclosed fuel cell can operate due to the selectivity of the catalysts. For example, using a short chain alcohol as the fuel in a 10% (range 2% to 25%) KOH (or other alkaline) electrolyte solution (from about 2 M to about 3 M), uses a palladium catalyst on the anode side and a cobalt (oxide) catalyst on the cathode side. Such a fuel cell can produce steady power output of approximately 20 mW per cm² area of catalyst/electrode.

The present disclosed fuel cell is distinguished, in part, by the absence of the permselective membrane or other permselective chemical barrier between the anode and cathode. Removal of this permselective membrane is possible because the anode and cathode catalysts are chosen, together with their fuels and the supporting electrolyte, so that the anode and cathode fuels and the fuel cell electrolyte can intermingle without substantial chemical cross reaction. As a result, oxidation of the anode fuel and reduction of the cathode fuel occur to a substantial extent only at the anode and cathode, respectively. Moreover, the catalysts used in the disclosed fuel cell results in only partial oxidation of the primary alcohol anode fuel, for example, ethanol fuel is converted to acetic acid or acetate, rather than complete oxidation all the way to carbon dioxide.

The electrolyte (typically comprising an electrolyte salt and supporting solvent) is selected using a number of criteria:

(i) that the electrolyte is of sufficient ionic conductivity to support the desired cell potential and current;
(ii) that the electrolyte salt and solvent do not interfere with the reactions between the electrodes and their corresponding fuels, or otherwise foul the electrodes;
(iii) that the electrolyte is available in sufficient quantities and with economics appropriate for the application; and
(iv) that in the case where an electrode is positioned at the interface between the electrolyte and the corresponding fuel, the electrolyte can be matched with an anode or cathode current collector and/or with an appropriate gaseous fuel pressure, so that it does not flood the current collector.

Ethanol was selected as the anode fuel for demonstration purposes due to its wide availability, portability, safety, and low cost, and oxygen is selected as the cathode fuel due to its wide availability and low cost as a component of ambient air. Subsequently, the anode catalyst was selected to be palladium, which is known to oxidize alcohols in alkaline media at about −0.5 V vs. a standard hydrogen electrode. Cobalt was selected as the cathode catalyst because it is known to reduce oxygen at about +0.5 V vs. a standard hydrogen electrode. Both catalysts are available in quantities sufficient for the application, based on annual worldwide mining production data.

Alternately, the fuel cell may comprise an anode electrode, a single compartment containing an electrolyte, fuel and cathode reactant, where the anode and cathode electrodes are physically separated with a mechanical or porous separator, which allows liquid to pass freely, to maintain electrode potential. Preferably, the separator is made from porous polyetheretherketone or PEEK.

The disclosed fuel cell is distinguished, in part, by the absence of the permselective membrane or other permselective chemical barrier between the anode and cathode. Removal of this permselective membrane is possible because the anode and cathode catalysts are chosen, together with their fuels and the supporting electrolyte, so that the anode and cathode fuels and the fuel cell electrolyte can intermingle without substantial chemical reaction. As a result, oxidation of the anode fuel and reduction of the cathode fuel occur to a substantial extent only at the anode and cathode, respectively.

### Permselective Membrane-Less Fuel Cell Process

The disclosed process for making a permselective membrane-less fuel cell having the requisite power densities relies on use of catalysts and fuels that react independently to a degree required by a commercial application. For example, in a first embodiment a fuel cell comprises a palladium-based anode assembled together with an ethanol fuel dispersed in an alkaline electrolyte and a cobalt-based cathode. Regardless of the operating rate of the resultant fuel cell, the presence of the oxygen fuel for the cathode in the alkaline electrolyte does not affect appreciably the operation of the anode, and as such the anode catalyst reacts with the anode fuel independently of the cathode.

Alternately, a second embodiment is a fuel cell having a platinum-based anode assembled together with hydrogen fuel dissolved in an acidic electrolyte and a cobalt-based cathode. The resultant fuel cell is then operated in such a manner so that all of the cathodic fuel, oxygen, is consumed at the cathode as does not enter the electrolyte and interfere appreciably with the anodic reaction. As a result, the anode catalyst reacts with the anode fuel independently of the cathode. In some cases, including commercial applications requiring less than ten hours of operating time, this use of cathodic consumption of fuel to avoid depolarization of the cell is effected for systems in which the cathode does not consume all of the cathodic fuel and some dissolution of cathodic fuel into the electrolyte occurs. In these cases, since appreciable depolarization of the cell resulting from such dissolution, and subsequent reaction at the anode, of the cathodic fuel occurs over a timeframe longer than the operating timeframe of the cell, the depolarization has little or no effect on the commercial performance of the cell.

The disclosed liquid fuel cell can be operated by variety fuels, such as alcohols, particularly ethanol. The fuel concentration is from 0.5-20 M. An alkaline electrolyte is used. The operating temperature is from room temperature to 80° C. The fuel cell runs preferably at ambient pressure to reduce the parasitic power consumption. Methods of liquid fuel supply include continuous flow feed, dose feed, or dead-end (passive reservoir mode) feed. Methods of air supply can be either forced air flow or diffusion from ambient atmosphere

### Catalyst Composition and Structure

The present disclosure further provides fuel cells containing a wide range of anode catalysts, including platinum, palladium, nickel, copper, silver, gold, iridium, rhodium, cobalt, iron, ruthenium, osmium, manganese, molybdenum, chromium, tungsten, vanadium, niobium, titanium, indium, tin, antimony, bismuth, selenium, sulfur, aluminum, yttrium, strontium, zirconium, magnesium, lithium, and oxides thereof. The anode catalysts are preferably in their pure forms, as binary mixtures or alloys, as ternary mixtures or alloys, as quaternary mixtures or alloys, or are higher order mixtures or alloys. Alternatively, the anode catalysts are in their oxidized forms, as oxides, as sulfides, and as metal centers for coordination compounds including phosphorous-based ligands, sulfur-based ligands or other ligands. Alternatively, the anode catalysts are present in a conducting medium such as carbon powder.

In a preferred embodiment the present disclosure provides fuel cells containing anode catalysts based on such elements, or their alloys and mixtures, or their oxides, sulfides or coordination compounds, in their pure or dispersed forms, that are formed into particles that have at least one dimension that is less than 500 nanometers in length. Such particles can be spherical in nature, such as five nanometer palladium-coated carbon nanoparticles, or can be of other structures and morphology, such as ten micron long palladium-coated carbon rods that are two nanometers in diameter. Such particles can be mixtures of other particles that have a variety of aspect ratios and structures and compositions. Such particles can be prepared by, for example, electroplating onto the anode support.

The disclosure further provides fuel cells containing a wide range of cathode catalysts, including platinum, palladium, nickel, copper, silver, gold, iridium, rhodium, cobalt, iron, ruthenium, osmium, manganese, molybdenum, chromium, tungsten, vanadium, niobium, titanium, indium, tin, antimony, bismuth, selenium, sulfur, aluminum, yttrium, strontium, zirconium, magnesium, lithium, and similar elements. The cathode catalysts based on such elements are in their pure forms, as binary mixtures or alloys, as ternary mixtures or alloys, as quaternary mixtures or alloys, and as higher order mixtures or alloys. The cathode catalysts based on such elements are also alloys and mixtures, in their oxidized forms, as oxides, as sulfides, and as metal centers for coordination compounds including phosphorous-based ligands, sulfur-based ligands or other ligands. The cathode catalysts based on such elements are alloys and mixtures, in their pure form or physically and/or chemically dispersed in some manner in a conducting medium such as carbon powder. The cathode catalysts based on such elements are alloys and mixtures, or their oxides, sulfides or coordination compounds, in their pure or dispersed forms, that are formed into particles that have at least one dimension that is less than 500 nanometers in length. Such particles can be spherical in nature, such as five nanometer palladium-coated carbon nanoparticles, or can be of other structures and morphology, such as ten micron long palladium-coated carbon rods that are two nanometers in diameter. Such particles can be mixtures of other particles that have a variety of aspect ratios and structures and compositions. Such particles can be prepared by, for example, electroplating onto the cathode support.

### Support

The anode and cathode are made with porous support structures. The anode supports comprise one or more conducting materials prepared in a sheet, foam, cloth or other similar conductive and porous structure. The support can be chemically passive, and merely physically support the anode catalyst and transmit electrons, and/or it can be chemically or electrochemically active, assisting in the anode reaction, in pre-conditioning of fuel, in post-conditioning of anode reaction products, in physical control of the location of the electrolyte and other fluids, and/or in other similarly useful processes. Anode supports can include, for example, nickel foam, sintered nickel powder, etched aluminum-nickel mixtures, carbon fibers, and carbon cloth. Preferably, carbon materials are used as an anode support.

The cathode supports comprise one or more conducting materials prepared in a sheet, foam, cloth or other similar structure. The cathode support can be chemically passive, and merely physically support the cathode catalyst and transmit electrons, and/or it can be chemically or electrochemically active, assisting in the cathode reaction, in pre-conditioning of fuel, in post-conditioning of cathode reaction products, in physical control of the location of the electrolyte and other fluids, and/or in other similarly useful processes. Cathode supports can include nickel foam, sintered nickel powder, etched aluminum-nickel mixtures, metal screens, carbon fibers, and carbon cloth.

The disclosed fuel cells comprise anode and/or cathode supports that have been pre-treated in order to control flooding of the cathode. For example, a preferred fuel cell contains a cathode support comprised of carbon fiber that has been pre-treated by teflonization of carbon fiber paper. Pre-treatment comprises, briefly, preparing a solution with the desired concentration of PTFE (30-60 wt %) and stirring gently for at least 2 hours before use. Teflonization of the carbon fiber paper was done by laying the carbon fiber paper pieces flat in the PTFE solution for 30 seconds, making sure that the carbon fiber pieces were fully submerged. After 30 seconds, each piece was removed from solution and allowed to drip off for about 1 minute before laying them on a rack to dry for an hour at room temperature. Once dried, the PTFE treated carbon paper was sintered in a furnace, set to 335° C., for 15-20 minutes. Alternatively, a microporous layer (MPL) on carbon paper applied by an air spray method was also employed. A carbon ink is prepared, briefly, by providing about 140 mg of pre-treated carbon power and about 1 mL water and 0.2 mL Trition X-100 to form a solution. The solution was sonicated for about 30 seconds. About 100 mg of 60 wt % PTFE solution was added to the solution and the solution further sonicated for about 10 minutes, stopping about halfway through to mix the solution with a glass rod. The carbon fiber paper (treated with PTFE) was attached to a backing so that it stands upright in a hood. Once the carbon ink is prepared, the ink is transferred to an airbrush bottle, and sprayed onto carbon paper in thin, even layers, allowing time for each layer to dry before the next is applied. This process was continued until the ink is used up. The sprayed carbon paper was dried in the oven at 80° C. for 30 minutes. Once dried, the sprayed and dried carbon paper pieces were situated between aluminum foil squares and the MPL firmly pressed by running a roller over it 2-3 times. Next, the carbon paper was sintered by returning it to the oven, set to 120° C. for 10 minutes, and then to the furnace, set to 340° C. for 15 minutes. This pre-treatment provided a cathode support that was sufficiently hydrophobic so that the electrolyte, solvent and anode fuel contained in the single compartment does and did not flood the cathode and thereby interfere with the reduction of oxygen at the cathode catalysts.

A similar pre-treatment for an anode support can be carried out in order to likewise contain the electrolyte for a cell that uses a gaseous anodic fuel.

### Catalyst Application Options

Methods for applying the anode catalysts to the anode support and cathode catalysts to the cathode support include, for example, spreading, wet spraying, powder deposition, electro-deposition, evaporative deposition, dry spraying, decaling, painting, sputtering, low pressure vapor deposition, electrochemical vapor deposition, tape casting, and other methods.

### Separators

A key component of the disclosed fuel cell is a non-conducting separator that does not preclude appreciably free movement within a single compartment of the electrolyte, solvent, and any liquid anodic or cathodic fuel. Preferably, this separator is chemically inert to the materials present in the single compartment and physically inert to the temperatures, pressures, and chemical conditions present in the single compartment. This chemical and physical inertness of the separator is substantial at least over the desired lifetime of the fuel cell.

In some cases, the lack of inertness of a separator to a chemical or physical environment in the single compartment is used to determine a maximum lifetime of the fuel cell or to create a safety mechanism for a fuel cell. For example, a separator that degrades over time until it interferes substantially with ionic movement between the cathode and anode after 100 hours of operation of a fuel cell can be used to set the maximum lifetime of the cell at 100 hours.

In another example, a separator that melts and interferes substantially with ionic movement between the cathode and anode if the temperature in the single compartment exceeds 40° C. can be used to set the maximum operating temperature of the fuel cell at 100° C.

Examples of separators include dielectric materials such as polymers, glasses, mica, metal oxide, cellulose, and ceramics, among others. Such separators can be constructed as porous sheets or as uniformly-sized particles. In a preferred embodiment, the separator is a fixture surrounding the edges of the anode and cathode that holds the anode and cathode at a fixed distance apart while providing a containing shell between the electrodes that contains the electrolyte, solvent and fuel fluids so that they remain between the anode and cathode, and thereby creates the single compartment of the fuel cell.

In a preferred embodiment, a fine PEEK (polyetheretherketone) mesh was used as the separator. The separator was placed between an anode catalyst layer and a cathode catalyst. The edge of the PEEK mesh preferably was either pre-sealed or integrated with the cell sealing to prevent overboard leaking Preferably, the thickness of the PEEK mesh was 2-3 mm thick.

### Electrolytes and Solvents

The disclosure provides a fuel cell in which the anode and cathode catalyst-fuel systems are chosen so that they can operate independently even when the fuels are mixed. The solvent and electrolyte used in the fuel cell have a significant effect on the electroactivities of the anode and cathode catalyst-fuel systems. The solvent and electrolyte facilitate those electroactivities, have no effect on the electroactivities, or reduce the electroactivities. For example, ethanol is oxidized at palladium in alkaline aqueous media. In this case, the present fuel cell uses a water solvent that contains a strong base to facilitate oxidation of ethanol at the palladium catalyst. Selection of a cathode catalyst-fuel system that can operate in alkaline media is important.

Solvents and electrolytes interact with the anodic fuel to facilitate the electroactivity of that fuel at the anode. The solvent and electrolyte interact with the cathodic fuel to facilitate the electroactivity of that fuel at the cathode. The concentration of electrolyte is chosen to facilitate electroactivity of one or more of the fuels, to minimize adverse interactions between the electrolyte and one or more of the catalysts, to maximize ionic conductivity and current density of the fuel cell, and to minimize acidity or alkalinity (i.e., safety concerns) of the fuel cell.

Examples of electrolytes include dissolved salts such as bases like potassium hydroxide, NaOH, K₂CO₃, Na₂CO₃, NH₃.H₂O, acids such as sulfuric acid, sulfonic acid, and combinations thereof.

A key advantage of the disclosed process is economics. The ability to produce both electric power to sell and chemicals to sell, all without producing carbon dioxide, provides significant economic advantages in a commercial embodiment. For example, a revenue model is shown in the Table below:

Fuel Cell Output

| | | Revenue | | Cost |
|---|---|---|---|---|
| Methanol Feed/mT | | | | |
| (metric ton) | | | | |
| Electric Power Raw (Whr) | 2,027,170 | $81.09 | Methanol ($/mT) | $199.79 |
| Electric Power + Heat (Whr) | 2,838,038 | $113.52 | Capital ($/MWh) | $10.00 |
| Formic Acid (kg) | 1,500 | $1,965.00 | Operating ($/MWh) | $15.00 |
| Carbon (kg) | 375 | $21.45 | | $224.79 |
| | | $2,099.97 | | |
| | | | Gross Prof | $1,875.18 |
| | | | ($/MWhr) | |

OR

| | | | | |
|---|---|---|---|---|
| Ethanol Feed/mT | | | | |
| Electric Power (Whr) | 1,410,205 | $56.41 | Ethanol ($/mT) | $566.07 |
| Electric Power + Heat (Whr) | 1,974,287 | $78.97 | Capital ($/MWh) | $10.00 |
| Acetic Acid (kg) | 1,348 | $862.61 | Operating ($/MWh) | $15.00 |
| Carbon (kg) | 522 | $29.84 | | $591.07 |
| | | $1,027.83 | | |
| | | | Gross Prof | $436.76 |
| | | | ($/MWhr) | |

OR

| | | | | |
|---|---|---|---|---|
| Ethelene glycol Feed/mT | | | | |
| Electric Power Raw (Whr) | 2,092,563 | $83.70 | Ethylene ($/mT) | $683.43 |
| Electric Power + Heat (Whr) | 2,929,588 | $117.18 | Capital ($/MWh) | $10.00 |
| Oxalic Acid (kg) | 1,452 | $881.84 | Operating ($/MWh) | $15.00 |
| Carbon (kg) | 387 | $22.14 | | $708.43 |
| | | $1,104.87 | | |
| | | | Gross Prof | $396.44 |
| | | | ($/MWhr) | |

OR

| | | | | |
|---|---|---|---|---|
| Coal Syngas OH Feed | | | | |
| MeOH/EtOH | 1.50 | | Coal Syngas OH ($/mT) | $33.00 |
| MeOH (kg) | 600 | | Capital ($/MWh) | $15.00 |
| EtOH(kg) | 400 | | Operating ($/MWh) | $25.00 |
| Electric Power Raw (Whr) | 1,780,384 | $71.22 | | $73.00 |
| Electric Power + Heat (Whr) | 2,492,538 | $99.70 | | |
| Formic Acid (kg) | 900 | $1,179.00 | | |
| Acetic Acid (kg) | 539 | $345.04 | | |
| Carbon (kg) | 434 | $24.81 | | |
| | | $1,719.77 | | |
| | | | Gross Prof | $1,646.77 |
| | | | ($/MWhr) | |

As can be seen from the table, the disclosed process and system provides significant economic benefits over standard combustion of coal or natural gas, with or without cap-and-trade laws in place.

### Example 1

The present example reviews the economics of coal utilization for electric power production in the environment of an established cap and trade system for carbon credits and for making power, coke and acetic acid in a cap and trade system with the same unit of coal, but not generating carbon dioxide or another kind of greenhouse gas. This economic analysis will utilize the following estimates and assumptions. Firstly, it is known that the combustion of about one ton of coal, particularly bituminous coal, produces about 3 tons of carbon dioxide. Based upon current pricing (February 2009 in the absence of a cap and trade system) a ton of Wyoming coal costs about $13 per ton but can produce about $80 in revenue for the power produced by combusting such coal in a coal-fired power plant. A ton of Appalachian coal costs about $60 per ton and is more energy dense so it can produce about $120 worth of power after combustion at a rate of $60 per MWh with each ton of coal producing about 2 MWh of electric power. This example assumes that all power produced is sold and there is no carbon tax levied under a cap and trade system.

It has been estimated that the purchase of a carbon credit (or tax) to release a ton of CO₂ will costs about $50 or a total of $150 to burn one ton of coal over and above a plant's allotment of carbon credits. While the actual market price is not yet known, the $50 number is an estimate and if it is lower, the numbers provided in this economic analysis can be adjusted accordingly. Similarly, a plant using the disclosed process and purchasing one ton of coal will receive up to $150 by selling its carbon credits to facility that combusts coal or natural gas. As one can see, particularly with a coal-fired plant in Wyoming buying Wyoming coal, the implementation of a cap and trade system, at current coal costs and power rates essentially makes coal-fired electricity generation unprofitable and likely to close each power plant. However, conversion to plants that produce coke, power and acetic acid, according to the disclosed process, will restore profitable economics to such a facility and utilization of coal that would otherwise be shut down as an industry.

This example will use a hypothetical plant in Cheyenne, Wyo. that uses Wyoming coal and a plant near Cleveland, Ohio that uses Appalachian coal. The unit of coal in the example is one ton.

### Cheyenne

Power generation will provide about $80 of revenue for the power generated, and the costs will be $13 for the coal plus $150 to purchase the carbon credits. Therefore, utilizing the Cheyenne plant for power generation under a cap and trade system is not economic unless power rates skyrocket. Using the disclosed process, the Cheyenne will receive in revenue approximately $100 for power generation and for selling the coke generated, plus $150 to sell its carbon credit, plus about $600 for one ton of acetic acid generated and sold, and its cost for materials will be $13 for the coal. Clearly, the disclosed process compels the hypothetical Cheyenne facility to shift away from combustion of coal and toward the disclosed process a much more profitable if a cap and trade system is implemented.

### Cleveland

There are similar beneficial economics for a Cleveland facility using the disclosed process. Power generation under a cap and trade system will provide revenue of $225 with costs of $60 for the coal plus $150 to purchase the carbon credits, resulting in a gain (before capital costs, depreciation, labor, taxes, etc.) of $15 per ton. Thus, power rates would have to rise significantly to keep burning coal in Cleveland.

Using the process disclosed herein, a plant in Cleveland can obtain revenue of $225 for coke and power sold, plus $150 for selling carbon credits, plus $600 for a ton of acetic acid for a total of $975 per ton of coal. Costs will be $60 for the coal or a gross profit of $915 before capital costs, depreciation, labor, taxes, etc.). In fact, even in the absence of a cap and trade system, the hypothetical plant in Cleveland is better off stopping combusting coal and switching to the disclosed process.

In addition, the “TARP” legislation passed the end of 2008 to bail out banks and financial institutions also included a provision to provide tax credits for fuel cell purchases of $3000 per kW of capacity to provide favorable economics to convert plants to the disclosed method.

Accordingly, the disclosed process provides more favorable economics for utilizing coal for generating power versus coal combustion under a cap and trade system irrespective of the market price for a carbon tax or credit.

### Example 2

This example provides the results of a serious of experiments to analyze the fuel that was run through the liquid fuel cell system described herein. Specifically, an ethanol primary alcohol fuel was mixed into a KOH electrolyte and then run (and recirculated) through the fuel cell for 3 hours at 50 mA/cm². The waste fuel was collected and then neutralized with HCl. One portion of the neutralized waste was extracted with diethyl ether and in the other portion extracted with chloroform. Both portions were then separated on a gc capillary column using a carbowax stationary phase. Both portions were analyzed in a mass spec. The only product observed was acetic acid which was the small peak with a longer retention time than the solvent and ethanol. A NIST reference mass spectrum was used as a reference to identify the acetic acid peak. No evidence of acetaldehyde or other byproducts was observed.

I claim:

1. A process comprising:
(a) forming syngas;
(b) forming a primary alcohol or polyol from the syngas;
(c) providing the primary alcohol or polyol to a fuel cell; and
(d) producing power from the fuel cell while converting the primary alcohol or polyol to its corresponding carboxylic acid moiety or salt thereof.

2. The process of claim 1 wherein the primary alcohol or polyol is selected from the group consisting of methanol, ethanol, propanol, isopropanol, ethylene glycol, glycerol, 1,6-dihydroxy hexane, and combinations or mixtures thereof.

3. The process of claim 2 wherein the primary alcohol is selected from the group consisting of methanol, ethanol, ethylene glycol and combinations thereof.

4. The process of claim 1 wherein the primary alcohol or polyol is mixed with base to form a fuel in electrolyte for the fuel cell.

5. The process of claim 1 wherein the fuel cell has a cathode having a hydrophobic surface to prevent cathode flooding.

6. The process of claim 1 wherein the fuel cell comprises:
(a) an enclosed fuel cell having an anode chamber and a cathode chamber, wherein the anode chamber is separated from the cathode chamber by a porous separator that allows the free transfer of liquids and ions between the chambers and has an average pore diameter of from about 10 nm to about 100nm;
(b) the anode chamber comprises an anode electrode having a catalyst thereon, and a mixture of fuel and an electrolyte; and
(c) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm² of electrode area.

7. The process of claim 1 wherein the fuel comprises a primary alcohol or polyol at a concentration of from about 5% (by volume) to about 100% (by volume).

8. The process of claim 7 wherein the concentration of alcohol or polyol is from about 10% to about 50% by volume.

9. The process of claim 1 wherein the coated electrode cathode is coated by a hydrophobic polymer selected from the group consisting of polyamides, polyimides, fluoropolymers, organosubstituted silica, organo-substituted titania, and combinations thereof.

10. A process for generating power in a fuel cell and for forming acetate or formate or oxalate through an incomplete oxidation of ethanol or methanol or ethylene glycol or glycerol, comprising:
(a) providing a fuel cell comprising:
(i) an enclosed fuel cell having an anode chamber and a cathode chamber, wherein the anode chamber is separated from the cathode chamber by a porous separator that allows the free transfer of liquids and ions between the chambers;
(ii) the anode chamber comprises an anode electrode having a catalyst thereon, and a mixture of fuel and an electrolyte; and
(iii) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm²; and
(b) mixing the ethanol or methanol or both with base to form the fuel for the fuel cell.

11. The process for generating power in a fuel cell and for forming acetate or formate or oxalate through an incomplete oxidation of ethanol or methanol or ethylene glycol or glycerol of claim 10, wherein the fuel cell has a cathode having a hydrophobic surface to prevent cathode flooding.

12. The process for generating power in a fuel cell and for forming acetate or formate or oxalate through an incomplete oxidation of ethanol or methanol or ethylene glycol or glycerol of claim 10, wherein the fuel comprises methanol or ethanol or both at a concentration of from about 5% (by volume) to about 100% (by volume).

13. The process for generating power in a fuel cell and for forming acetate or formate or oxalate through an incomplete oxidation of ethanol or methanol or ethylene glycol or glycerol of claim 12, wherein the concentration of methanol or ethanol or both is from about 10% to about 50% by volume.

14. The process for generating power in a fuel cell and for forming acetate or formate or oxalate through an incomplete oxidation of ethanol or methanol or ethylene glycol or glycerol of claim 10, wherein the fuel mixture further comprises an electrolyte wherein the electrolyte is selected from the group consisting of a base, an acid, a non-aqueous base, a non-aqueous acid.

15. The process for generating power in a fuel cell and for forming acetate or formate or oxalate through an incomplete oxidation of ethanol or methanol or ethylene glycol or glycerol of claim 10, wherein the coated electrode cathode is coated by a hydrophobic polymer selected from the group consisting of polyamides, polyimides, fluoropolymers, organo-substituted silica, organo-substituted titania, and combinations thereof.

16. A process for generating power in a fuel cell with a carbon-based fuel and preventing carbon release, comprising:
(a) providing one or a plurality of fuel cells, wherein each fuel cell comprises:
(i) an enclosed fuel cell having an anode chamber and a cathode chamber, wherein the anode chamber is separated from the cathode chamber by a porous separator that allows the free transfer of liquids and ions between the chambers;
(ii) the anode chamber comprises an anode electrode having a catalyst thereon, a mixture of fuel and an electrolyte, a fuel inlet and a spent fuel outlet; and
(iii) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm²;
(b) providing a primary alcohol fuel added to the inlet of the anode chamber and a spent fuel obtained through the outlet of the anode chamber, wherein the spent fuel is substantially a carboxylic moiety from the primary alcohol;
(c) obtaining corresponding carboxylic acids from the spent fuel outlet of the anode chamber;
(d) feeding the carboxylic acids from the spent fuel outlet of the anode chamber to a gasifier that functions as an anaerobic combustion chamber to provide waste hydroxide salts and syngas; and
(e) forming primary alcohol from the syngas.

17. The process for generating power in a fuel cell with a carbon-based fuel and preventing carbon release of claim 16, wherein the fuel cell has a cathode having a hydrophobic surface to prevent cathode flooding.

19. The process for generating power in a fuel cell with a carbon-based fuel and preventing carbon release of claim 16, wherein the fuel comprises a primary alcohol or polyol at a concentration of from about 5% (by volume) to about 100% (by volume).

20. The process for generating power in a fuel cell with a carbon-based fuel and preventing carbon release of claim 19, wherein the concentration of the primary alcohol or polyol is from about 10% to about 50% by volume.

21. The process for generating power in a fuel cell with a carbon-based fuel and preventing carbon release of claim 16, wherein the fuel mixture further comprises an electrolyte wherein the electrolyte is selected from the group consisting of a base, an acid, a non-aqueous base, a non-aqueous acid.

22. The process for generating power in a fuel cell with a carbon-based fuel and preventing carbon release of claim 16, wherein the coated electrode cathode is coated by a hydrophobic polymer selected from the group consisting of polyamides, polyimides, fluoropolymers, organo-substituted silica, organo-substituted titania, and combinations thereof.

23. The process for generating power in a fuel cell with a carbon-based fuel and preventing carbon release of claim 16, wherein the spent fuel is recirculated back to the inlet of the anode chamber in case additional primary alcohol was not completely converted to its corresponding carboxylic acid.

24. A closed loop system for converting a carbon source to power while avoiding atmospheric release of carbon containing greenhouses gases, comprising:
(a) one or a plurality of fuel cells, wherein each fuel cell comprises:
(i) an enclosed fuel cell having an anode chamber and a cathode chamber, wherein the anode chamber is separated from the cathode chamber by a porous separator that allows the free transfer of liquids and ions between the chambers;
(ii) the anode chamber comprises an anode electrode having a catalyst thereon, a mixture of fuel and an electrolyte, a fuel inlet and a spent fuel outlet; and
(iii) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm²;
(b) a mixed primary alcohol fuel mixture added to the inlet of the anode chamber and a spent fuel consisting essentially of a carboxylic acid moiety where the original primary hydroxyl moiety was, obtained through the outlet of the anode chamber, wherein the spent fuel is substantially a carboxylic moiety of the original primary alcohol; and
(c) a gasifier capable of functioning as an anaerobic combustion chamber and having one or a plurality of input ports for the carbon source, carboxylic acids and air and an output port. for solid products and alcohols.

25. The closed loop system for converting a carbon source to power while avoiding atmospheric release of carbon containing greenhouses gases of claim 24, wherein the carbon source is selected from the group consisting of solid hydrocarbons, coal, coal dust, liquid hydrocarbons, alkane gases, and combinations thereof.

26. The closed loop system for converting a carbon source to power while avoiding atmospheric release of carbon containing greenhouses gases of claim 24, wherein the fuel cells are connected in a parallel configuration or a combination parallel and serial configuration.

27. The closed loop system for converting a carbon source to power while avoiding atmospheric release of carbon containing greenhouses gases of claim 24, wherein the output of each fuel cell is tied together to a single input in a gasifier.

28. The closed loop system for converting a carbon source to power while avoiding atmospheric release of carbon containing greenhouses gases of claim 27, wherein the fuel cell outputs are scrubbed to remove any SOx, NOx or heavy metals contained in the carboxylic acid stream produced.

29. The closed loop system for converting a carbon source to power while avoiding atmospheric release of carbon containing greenhouses gases of claim 24, wherein the one or plurality of inputs for the gasifier provide an inlet for carbon source, carboxylic acids and optionally air, wherein the air input is shut when anaerobic combustion is required and the air input is open for aerobic combustion to produce heat and make electric power from heat.

30. The closed loop system for converting a carbon source to power while avoiding atmospheric release of carbon containing greenhouses gases of claim 30, wherein the fuel cell has a cathode having a hydrophobic surface to prevent cathode flooding.

31. The closed loop system for converting a carbon source to power while avoiding atmospheric release of carbon containing greenhouses gases of claim 24, wherein the fuel comprises an alcohol or polyol at a concentration of from about 5% (by volume) to about 100% (by volume).

32. The closed loop system for converting a carbon source to power while avoiding atmospheric release of carbon containing greenhouses gases of claim 24, wherein the fuel is ethanol or methanol or ethylene glycol or glycerol or mixtures thereof.

33. The closed loop system for converting a carbon source to power while avoiding atmospheric release of carbon containing greenhouses gases of claim 24, wherein the coated electrode cathode is coated by a hydrophobic polymer, selected from the group consisting of polyamides, polyimides, fluoropolymers, organo-substituted silica, organo-substituted titania, and combinations thereof.
